(19) United States
(12) Patent Application Publication
(10) Pub. No.: US 2004/0152612 A1
(43) Pub. Date: Aug. 5, 2004

(54) Coenzyme q10 containing microemulsion preconcentrates and microemulsions

(76) Inventors: Andreas Supersaxo, Baar (CH); Hans Georg Weder, Ruschlikon (CH); Marc Antoine Weder, Ruschlikon (CH)

Correspondence Address: SHOEMAKER AND MATTARE, LTD, 10 POST OFFICE ROAD - SUITE 110, SILVER SPRING, MD, 20910, US

(21) Appl. No.: 10/474,034

(22) PCT Filed: Mar. 4, 2002
(86) PCT No.: PCT/EP02/02284

(30) Foreign Application Priority Data
Apr. 12, 2001 (EP) 01109131.1

(51) Int. Cl. C11D 17/00

(52) U.S. Cl. 510/407; 510/421

(57) ABSTRACT

The present invention relates to novel active ingredient formulations in the form of microemulsion products, to processes for the preparation thereof and to the use thereof as carrier system for therapeutic active ingredients which are slightly soluble in water. The formulations of the invention are particularly suitable for oral administration.

The present invention relates to novel formulations in the form of microemulsion preconcentrates and microemulsions, and to the use thereof as carrier systems for active ingredients from the ubiquinone class which are slightly soluble in water, where appropriate also in combination with vitamins and trace elements. The formulations of the invention are particularly suitable for oral administration in the form of unit dose forms.

Ubiquinones can be detected in relatively large quantities in virtually all organisms; the only exceptions are Gram-positive and cyanobacteria. Ubiquinones are referred to as Q1, Q2, Q3 etc. depending on the number of isoprene units linked in the side chain. They occur preferentially with particular chain lengths, for example with n=6 in some microorganisms and yeasts. In most mammals, including humans, coenzyme Q10, also referred to as ubidecarenone, predominates. The human body synthesizes part of its coenzyme Q10 requirement itself, and the remainder is taken in with the diet. There is a continuous decline in endogenous production of coenzyme Q10 with increasing age.

The diverse effects of coenzyme Q10 are based both on its biological functions in the energy balance of the cells and on its antioxidant properties. Because of these effects, coenzyme Q10 is employed for the prophylaxis and/or treatment of the following disorders:

cardiovascular disorders such as myocardial infarction, angina pectoris, atherosclerosis and high blood pressure,

degenerative disorders of the central nervous system such as Alzheimer's, Parkinson's and depressions,

gingival disorders

muscular dystrophy

male infertility,

for strengthening the immune system and for improving physical capacity.

Coenzyme Q10 is also able to prevent or reduce side effects of certain drug products, e.g. those of statins such as lovastatin, pravastatin and simvastatin or of cytostatics such as doxorubicin.

Coenzyme Q10 is a lipophilic (i.e. hydrophobic) substance with very low solubility in water (practically insoluble in water). Formulations of coenzyme Q10, e.g. for oral administration, are therefore mainly based on the use of oils or similar excipients as carrier media. The products for oral administration formulated in this way and currently available commercially, such as, for example, Super Bio-Quinone (Pharma Nord), Bio Coenzyme Q10 (Solanova) and Q-Gel Ultra (Tishcon) have a very low bioavailability.

It is an object of the present invention to develop a formulation which improves the bioavailability of coenzyme Q10. It has surprisingly been found that on administration of formulations based on a microemulsion preconcentrate the oral bioavailability of coenzyme Q10 is significantly higher than for the commercially available products mentioned above.

The microemulsion preconcentrate of the invention means a system which affords a microemulsion on contact with water or another aqueous medium such as simulated gastric or intestinal fluid, e.g. on addition to water. A microemulsion of this type comprises in the conventionally acknowledged sense a non-opaque or virtually non-opaque colloidal dispersion which comprises water and organic components with inclusion of lipophilic (i.e. hydrophobic) components.

Microemulsions in the sense of the invention can be identified by the fact that they have one or more of the following properties:

They are formed spontaneously when their components are brought into contact with one another; thus, virtually no energy input is necessary for this, and the formation of such microemulsions therefore takes place without heating or use of a high shear force or another substantial mixing.

They are virtually non-opaque, namely transparent or opalescent, when they are examined under an optical microscope. In their undisturbed state, they are optically isotropic, although an anisotropic structure can be detected on inspection for example using an X-ray technique.

They contain a disperse or particulate (droplet) phase whose particles have a size of less than 200 nm, this being the origin of their optical transparency. The particles may be spherical or else have other structures; for example, they may be liquid crystals with lamellar, hexagonal or isotropic symmetries. In general, microemulsions comprise droplets or particles with a maximum dimension, for example a diameter, of less than 150 nm, usually about 10-100 nm.

The microemulsion preconcentrates of the invention are accordingly pharmaceutical systems which comprise a therapeutic active ingredient from the ubiquinone class which is slightly soluble in water, and are able to form a microemulsion spontaneously or virtually spontaneously, i.e. with a negligible energy input, on being brought into contact with water or gastric and intestinal fluid.

The microemulsion preconcentrates of the invention are characterized in that they comprise a mixture consisting of

(a) a mixture consisting of a medium chain triglyceride and an omega-9 fatty acid and/or an omega-6 fatty acid,

(b) a surface-active component comprising a surfactant of the polyoxyethylene type, and

(c) a therapeutic active ingredient from the ubiquinone class which is slightly soluble in water but soluble in component (a) and/or (b).

The ratio of the ingredients (a): (b): (c), (a): (c) or (b) (c) of the microemulsion of the invention must, of course, be chosen so that the active ingredient (c) is stably solubilized, i.e. precipitates must not occur over several weeks.

In contrast to prior art formulations, the microemulsion preconcentrates of the present invention are essentially free of water-miscible or water-soluble components. These are, in particular, the components

C₁-C₅-alkyl or tetrahydrofurfuryl diether or partial ether of low molecular weight mono- or polyoxy-C₂-C₁₂-alkanediols;

1,2-propylene glycol;

lower alkanols;

products of the esterification of polycarboxylic acids with 2-10, in particular 3-5, carboxyl groups with C₁-C₁₀ alcohols; and

products of the esterification of polyols with 2-10, in particular 3-5, carboxyl groups with C₂-C₁₁ carboxylic acids;

in particular essentially free of diethylene glycol monomethyl ether, glycofurol, 1,2-propylene glycol, triethyl citrate, tributy citrate, acetyl tributy citrate, acetyl triethyl citrate, triacetin, ethanol, polyethylene glycol, dimethyl isosorbitol and propylene carbonate.

In contrast to relevant formulations disclosed in WO 98/40051 A, component (a) of the microemulsion preconcentrate of the invention comprises in addition to a medium chain triglyceride an omega-9 fatty acid and/or an omega-6 fatty acid, which is surprisingly associated with a particularly pronounced stability of the microemulsions of the invention, which is of crucial importance for their therapeutic utilizability.

The microemulsion preconcentrates of the invention can be produced by intimately mixing the individual ingredients with one another, where appropriate with heating. The microemulsion preconcentrates can also be produced by dissolving component (b) with stirring, where appropriate with heating, in component (a), and adding component (c) to the resulting solution with further stirring. It is particularly important in this connection that the component or the active ingredient (c) is soluble either in component (a) or component (b) or else in both components (a) and (b), and that the active ingredient always continues to be in dissolved form during production of the precondensate, i.e. the mixture of all three components (a), (b) and (c).

Suitable as component (a) are mixtures of a medium chain fatty acid triglyceride, expediently a fatty acid triglyceride in which the fatty acid residues have 4 to 18, preferably 6 to 18, C atoms, of an omega-9 and/or an omega-6 fatty acid. These substances are immiscible with water or insoluble or pratically insoluble in water and have no or virtually no surface-active function.

Preferred medium chain fatty acid glycerides are caprylic/capric acid triglycerides as are known and available commercially for example under the trade name Miglyol (Fiedler, Lexikon der Hilfsstoffe, 3rd edition, pages 808 to 809, 1989). These include, for example, the following products:

Miglyol 810, 812 and 818

This is a fractionated coconut oil which contains triglycerides of caprylic and capric acids and has a molecular weight of about 520 (Miglyol 810 and 812) or 510 (Miglyol 818). It has a fatty acid composition with a maximum of 2 percent (Miglyol 810) and 3 percent (Miglyol 812 and 818) C₆, and with about 65 to 75 percent (Miglyol 810), 50 to 65 percent (Miglyol 812) and 45 to 60 percent (Miglyol 818) C₈. C₁₀ represents 25 to 35 percent of Miglyol, about 30 to 45 percent of Miglyol 812 and about 25 to 40 percent of Miglyol 818, and C₁₂ a maximum of 2 percent (Miglyol 810), 5 percent (Miglyol 812) and 2 to 5 percent (Miglyol 818). Miglyol 818 additionally has a content of about 4 to 6 percent of C_{18:2}.

Also suitable are triglycerides of caprylic and capric acid which are known and obtainable under the trade name Myritol (Fiedler, Lexikon der Hilfsstoffe, 3rd edition, page 834, 1989). These include, for example, the product Myritol 813.

Further suitable products of this class are Captex 355, Captex 300, Captex 800, Capmul MCT, Neobee M5 and Mazol 1400.

Suitable omega-9 fatty acids are mainly those having 12-24, in particular 16-24, preferably 18-22, C atoms, for example oleic acid and eicosatrienoic acid. Oleic acid is particularly preferred.

Suitable omega-6 fatty acids are mainly those having 12-24, in particular 16-24, preferably 18-22, C atoms, for example linoleic acid, gamma-linolenic acid, dihommo-gamma-linolenic acid and arachidonic acid. Linoleic acid is particularly preferred.

In a particularly preferred embodiment, a mixture consisting of a caprylic/capric acid triglyceride, oleic acid and/or linoleic acid is used as component (a).

Component (c), the therapeutic active ingredient from the ubiquinone class which is slightly soluble in water but soluble in component (a) and/or (b), is preferably coenzyme Q10; however, it is also possible to use another suitable ubiquinone, where appropriate in combination with vitamins, preferably vitamin E, and/or trace elements.

Component (b), the surface-active component comprising a surfactant of the polyoxyethylene type, may be a hydrophilic surface-active agent or a lipophilic surface-active agent, but mixtures of such agents are also suitable.

Examples of such surfactants are the following:

Products of the reaction of natural or hydrogenated vegetable oils and ethylene glycol, namely polyoxyethylene glycolated natural or hydrogenated vegetable oils such as polyoxyethylene glycolated natural or hydrogenated castor oils. The various surfactants known and obtainable under the name Cremophor (Fiedler, Lexikon der Hilfsstoffe, 3rd edition, pages 326 to 327, 1989) are particularly suitable, especially the products with the names Cremophor RH 40, Cremophor RH 60 and Cremophor EL. Also suitable as such products are the various surfactants known and obtained under the name Nikkol, for example Nikkol HCO-60.

Polyoxyethylene sorbitan fatty acid esters, for example the mono- and trilauryl esters, the mono- and tripalmityl esters, the mono- and tristearyl esters and the mono- and trioleyl esters, as are known and obtainable under the name Tween (Fiedler, Lexikon der Hilfsstoffe, 3rd edition, pages 1300 to 1304, 1989), for example the products

Tween 20: polyoxyethylene 20 sorbitan monolaurate,

Tween 40: polyoxyethylene 20 sorbitan monopalmitate,

Tween 60: polyoxyethylene 20 sorbitan monostearate,

Tween 80: polyoxyethylene 20 sorbitan monooleate,

Tween 65: polyoxyethylene 20 sorbitan tristearate,

Tween 85: polyoxyethylene 20 sorbitan trioleate,

Tween 21: polyoxyethylene 4 sorbitan monolaurate,

Tween 61: polyoxyethylene 4 sorbitan monostearate and

Tween 81: polyoxyethylene 4 sorbitan monooleate.

Of this class of compounds, Tween 80 is particularly preferred.

Polyoxyethylene fatty acid esters, for example the polyoxyethylene stearic esters known and obtainable commercially under the name Myrj (Fiedler, Lexikon der Hilfsstoffe, 3rd edition, page 834, 1989), especially the product Myrj 52, and the polyoxyethylene fatty acid esters known and obtainable under the name Cetiol HE (Fiedler, Lexikon der Hilfsstoffe, 3rd edition, page 284, 1989).

Copolymers of polyoxyethylene and polyoxypropylene like those known and obtainable for example under the names Pluronic and Emkalyx (Fiedler, Lexikon der Hilfsstoffe, 3rd edition, pages 956 to 958, 1989), especially the product Pluronic F68.

Block copolymers of polyoxyethylene and polyoxypropylene like those known and obtainable for example under the name Poloxamer (Fiedler, Lexikon der Hilfsstoffe, 3rd edition, page 959, 1989), especially the product Poloxamer 188.

Polyethoxylated vitamin E derivatives, especially the product Vitamin E TPGS (d-alpha tocoperyl polyethylene glycol 1000 succinate, Eastman).

Polyethoxylated hydroxy fatty acid esters, especially the product Solutol HS 15 (polyoxyethylene 660 hydroxystearate, BASF).

Products of the transesterification of natural vegetable oil glycerides and polyethylene polyols. These include products of the transesterification of various, for example non-hydrogenated, vegetable oils such as corn oil, pumpkinseed oil, almond oil, peanut oil, olive oil and palm oil, and of mixtures thereof with polyethylene glycols, especially with those having an average molecular weight of 200-800. Various transesterification products of this type are known and obtainable under the name Labrafil (Fiedler, Lexikon der Hilfsstoffe, 3rd edition, page 707, 1989); of these, the products Labrafil M 1944 CS and Labrafil M 2130 CS are particularly suitable.

Ethylene oxide adducts of sterols and derivatives thereof, for example of cholesterol and derivatives thereof, such as products derived from sitosterol, campesterol, or stigmasterol, for example from soybean sterols and derivatives thereof (Fiedler, Lexikon der Hilfsstoffe, 3rd edition, pages 554 and 555, 1989), as are known and obtainable under the names Generol, especially the products Generol 122 E5, 122 E10 and 122 E25.

The microemulsion preconcentrates of the invention include both systems which comprise a single surface-active agent, and systems which comprise a mixture of two or more surface-active agents, e.g. Tween 80+Cremophor RH 40, Tween 80+Cremophor RH 40+Vitamin E TPGS etc.

A surface-active component preferably used according to the invention comprises a polyoxyethylene sorbitan fatty acid ester, a polyoxyethylene glycolated natural or hydrogenated vegetable oil or mixtures thereof.

The microemulsion preconcentrates of the invention may also comprise further substances such as, for example, antioxidants, thickeners, fragrances and/or flavorings, colors, etc.

The premicroemulsions of the invention are primarily intended for oral use. Preference is given in this connection to the so-called unit dose form, i.e. the microemulsion preconcentrate is accommodated in a shaped article such as a soft or hard capsule, e.g. made of gelatin or starch. When the active ingredient—containing premicroemulsion is released there is spontaneous formation of a microemulsion in conjunction with gastrointestinal fluid. The compositions of the invention prove to be particularly suitable for oral administration in the form of unit dose forms also because addition of volatile organic solvents, especially of the frequently used ethanol, is unnecessary. When said solvents are employed, evaporation thereof through the outer wall of the shaped article, especially of the soft or hard gelatin capsule, has an adverse effect on storability, and the active ingredient crystallizes out. The occurrence of these adverse effects must be prevented by elaborate measures during packaging and storage.

The novel compositions can also be processed further to effervescent tablets or as granules.

A unit dose form of the type described above expediently comprises from 0.5 to 25, preferably 10-20, percent by weight of a therapeutic active ingredient of the ubiquinone class (component (c)) which is slightly soluble in water but soluble in component (a) and/or (b), from 9.5 to 70, preferably from 20 to 70, percent by weight and further preferably from 25 to 65 percent by weight, of a mixture consisting of a medium chain triglyceride and an omega-9 fatty acid and/or an omega-6 fatty acid (component (a)) and from 20 to 90, preferably from 25 to 65, percent by weight of the surface-active component (b).

The present invention also makes it possible to provide pharmaceutical compositions which comprise a therapeutic active ingredient from the ubiquinone class which is slightly soluble in water but soluble in component (a), and which themselves represent microemulsions; the active ingredient is stably solubilized in these microemulsions, with no precipitates being observed over several weeks. For oral administration it is possible for microemulsions, which are obtained for example by diluting the microemulsion preconcentrates of the invention with water or an aqueous medium, to be used directly as drinkable formulations. If parenteral use is intended, then compositions, in which further excipients may be present, likewise contain water, resulting in an aqueous microemulsion in the form of a solution for injection, of a solution for infusion or the like.

Such pharmaceutical compositions in the form of microemulsions are likewise novel, and the present invention relates thereto.

The microemulsions of the invention can be prepared from the microemulsion preconcentrates of the invention by diluting with water or other aqueous liquids. When the preconcentrate is mixed with water or gastric and intestinal fluid there is spontaneous or virtually spontaneous, i.e. with negligible energy input, formation of a microemulsion.

Depending on the amount of water present, the microemulsions are W/O microemulsions, bicontinuous microemulsions or O/W microemulsions.

The O/W type (oil-in-water) microemulsions of the invention show stability properties like those described hereinbefore in connection with microemulsions, i.e. in particular that the active ingredient is stably solubilized in these microemulsions, and no precipitate is observable over several weeks. The particle size of these microemulsions is less than 150 nm, preferably less than 100 nm. The compositions of the invention are explained further by the following examples. Examples 1.1 to 1.3 show the preparation of compositions in oral unit dose forms which are suitable for example for the prophylaxis or therapy of cardiovascular disorders, degenerative disorders of the central nervous system, gingival disorders, muscular dystrophy, male infertility, for strengthening the immune system, for improving physical capacity and for preventing or reducing statin-induced side effects. Example 2.1 shows the preparation of a composition for parenteral use. In example 3 there is measurement of the oral bioavailability of a composition of the invention and comparison thereof with that of commercially available products.

The examples are described with particular reference to coenzyme Q10. However, comparable compositions can be prepared through use of other suitable ubiquinones, where appropriate in combination with vitamins, preferably vitamin E and/or trace elements.

### EXAMPLE 1

### Preparation of Oral Coenzyme Q10 Dosage Forms of the Microemulsion Preconcentrate Type

### Example 1.1

| | |
|---|---|
| Coenzyme Q10 (c1) | 10.00% |
| Miglyol 812 (a1) | 38.90% |
| Oleic acid (a2) | 6.00% |
| Tween 80 (b) | 45.00% |
| Vitamin E (c2) | 0.10% |

The coenzyme Q10 (c1) is dissolved by stirring in components (a1), (a2), (b) and (c2) at 40-45° C. The microemulsion preconcentrate which is formed is used to fill a soft or hard gelatin capsule or further processed to effervescent tablets.

An alternative possibility is also to use the micro-emulsion preconcentrate to fill a dispenser. In this case, the patient prepares an oral drinkable solution of the O/W microemulsion type from the microemulsion preconcentrate by appropriate dilution with water or another aqueous liquid.

The following compositions can also be prepared in an analogous manner.

### Example 1.2

| | |
|---|---|
| Coenzyme Q10 (c) | 10.00% |
| Miglyol 812 (a1) | 35.00% |
| Oleic acid (a2) | 10.00% |
| Tween 80 (b1) | 33.75% |
| Cremophor EL (b2) | 11.25% |

### Example 1.3

| | |
|---|---|
| Coenzyme Q10 (c) | 20.00% |
| Miglyol 812 (a1) | 25.00% |
| Oleic acid (a2) | 10.00% |
| Tween 80 (b1) | 33.75% |
| Cremophor EL (b2) | 11.25% |

Dilution, e.g. 1:10, of compositions of the above type with water results in microemulsions having the following particle sizes (cf. table 1):

TABLE 1

| | |
|---|---|
| Composition of | O/W microemulsion |

| microemulsion | Particle diameter¹⁾ | Standard deviation¹⁾ |
|---|---|---|
| preconcentrate | [nm] | [nm] |
| Example 1.1 | 35.7 | 14.2 |
| Example 1.2 | 26.6 | 9.8 |
| Example 1.3 | 28.0 | 10.6 |

¹⁾The particle diameters and particle size distribution were determined by dynamic laser light scattering measurements (instrument: Nicomp 370 submicron particle sizer, evaluation: volume weighting).

It is evident from the table below that the microemulsion formation remains unchanged after the microemulsion preconcentrates have been used to fill and have been stored in soft gelatin capsules (SGC).

TABLE 2

| | |
|---|---|
| | Particle diameter of the |
| Microemulsion | coenzyme Q10 microemulsion¹⁾ |

| preconcentrate of | Gastric fluid | Intestinal fluid |
|---|---|---|
| example 1.1 | [nm] | [nm] |
| Before SGC filling | 41.9 ± 18.1 | 39.0 ± 16.1 |
| After SGC filling | 41.5 ± 18.9 | 37.8 ± 19.5 |
| After storage in SGC | 45.2 ± 17.9 | 40.6 ± 16.8 |
| at 25° C. and 60% RH for | | |
| 1 month | | |
| After storage in SGC | 44.9 ± 20.2 | 39.5 ± 17.3 |
| at 40° C. and 75% RH for | | |
| 1 month | | |
| After storage in SGC | 43.0 ± 17.6 | 39.4 ± 17.1 |
| at 25° C. and 60% RH for | | |
| 3 months | | |
| ¹⁾The coenzyme Q10 microemulsions were formed by a 1:100 dilution of the microemulsion preconcentrates with simulated gastric and intestinal fluid at 37° C. Microemulsion preconcentrates used to fill SGC were removed from the SGC for the microemulsion formation. | | |
| #The particle diameters and particle size distribution of the resulting coenzyme Q10 microemulsions were determined by dynamic laser light scattering measurements (instrument: Nicomp 370 submicron particle sizer, evaluation: volume weighting). | | |

### Example 2

### Preparation of coenzyme Q10 forms of the microemulsion type which can be used parenterally

The microemulsion preconcentrates described in example 1.1 to 1.3 can serve as basis for preparing solutions for injection or infusion through appropriate dilution thereof with further additives such as physiological saline or 5% glucose solution and the like.

### Example 2.1:

### 0.10% coenzyme Q10 Solution for Infusion Microemulsion Preconcentrate of Example 1.2 1.00% 5% Glucose solution ad 100.00%

The liquid microemulsion preconcentrate is added to the glucose solution with stirring at room temperature. The resulting coenzyme Q10 O/W microemulsion is sterilized by 0.2 μm filtration and used to fill conventional sterile containers.

### Example 3

### Bioavailability of the Coenzyme Q10 Microemulsion Preconcentrate of Example 1.1 After Oral Administration in Soft Gelatin Capsules Compared With Three Commercially Available Products

The aim of this four-arm, double-blind, randomized study on 20 subjects of both sexes was to examine the plasma concentration of coenzyme Q10 after a single oral dose of 120 mg. For this purpose, blood samples were taken intermittently over 24 hours.

Preparations

A soft gelatin capsules comprising the coenzyme Q10 microemulsion preconcentrate of example 1.1

batch 201004

active ingredient content: 30 mg of coenzyme Q10 per capsule

B Q-Gel Ultra (Tishcon)

batch 19710060

active ingredient content: 60 mg of coenzyme Q10 per capsule

C Super Bio-Quinone (Pharma Nord)

batch 000956

active ingredient content: 30 mg of coenzyme Q10 per capsule

D Bio Coenzyme Q10 (Solanova)

batch 00310050

active ingredient content: 30 mg of coenzyme Q10 per capsule

Dosage

120 mg of coenzyme Q10, orally in 2 or 4 capsules

Intake

The 120 mg of coenzyme Q10 was taken orally on an empty stomach, before breakfast in the morning

Subjects

n=20, in 4 groups each of 5 subjects (A-D)

Measured parameters

Plasma levels of coenzyme Q10 [μg/ml plasma]

Analysis of the plasma samples

Coenzyme Q10 (ubidecarenone) was determined quantitatively by HPLC

| | |
|---|---|
| Instruments | Merck/Hitachi HPLC system, UV |
| | detection, autosampler F. Beckmann |
| | (Spectra Physics) |
| Separating column | Nucleosil RP 18 (5 μm), length |
| | 15 cm, diameter 4 mm, Merck |
| Eluent | acetonitrile |
| Metering loop | 100/20 μl |
| UV detector | 275 nm |
| Retention time | 10 min |
| Detection limit | 80 ng/ml |

Results

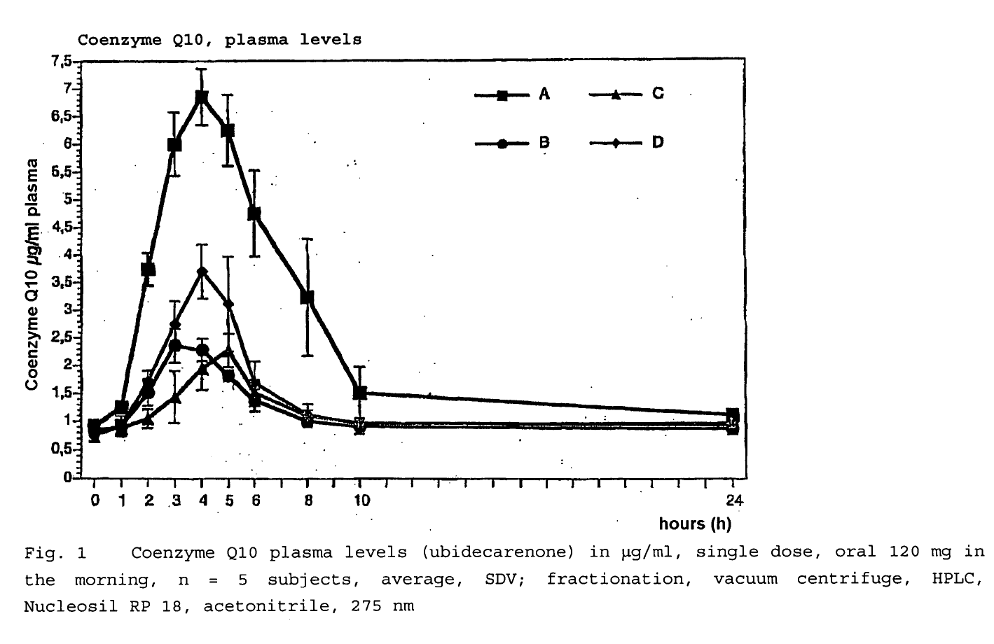

The profiles of plasma levels for products A-D show clear differences in relation to the maximum reached and the rate of rise in level (cf. FIG. 1). The significant differences in the bioavailability of coenzyme Q10 after a single oral dose can be clearly demonstrated from calculation of the AUC and of the relative available dose derived therefrom, based on a single dose of 120 mg. The composition of the invention (test product A) shows a bioavailability which is 3-5 times that of the test products B, C and D (cf. table 3).

TABLE 3

Test product

| | A | B | C | D |
|---|---|---|---|---|
| AUC [μg/ml/10 h] | 30.16 | 5.72 | 5.14 | 10.65 |
| Relative available dose based | 75.39 | 14.30 | 12.86 | 26.63 |
| on a single dose of 120 mg | | | | |

1. A composition in the form of a microemulsion precondensate comprising
(a) a mixture consisting of a triglyceride and an omega-9 fatty acid and/or an omega-6 fatty acid; and
(b) a surface-active component comprising a surfactant, in particular of the polyoxy-ethylene type,
(c) an active ingredient mixture comprising a ubiquinone, preferably Q10, in combination with vitamins, preferably vitamin E and derivatives thereof, and/or trace elements, where the ubiquinone is soluble in (a) and/or (b).

2. A composition in the form of a microemulsion obtainable by mixing a microemulsion precondensate as claimed in claim 1 with water or an aqueous medium.

3. A composition as claimed in claim 1 or 2, which is essentially free of water-miscible or water-soluble components.

4. A composition as claimed in any of claims 1 to 3, characterized in that the fatty acid residues of the triglyceride have 4-18, preferably 6-18, C atoms.

5. A composition as claimed in claim 4, characterized in that the triglyceride is a caprylic/capric acid triglyceride.

6. A composition as claimed in any of claims 1 to 5, characterized in that the omega-9 fatty acid and/or the omega-6 fatty acid has 12-24, in particular 16-24, preferably 18-22, C atoms.

7. A composition as claimed in any of claims 1 to 6, characterized in that the omega-9 fatty acid is oleic acid.

8. A composition as claimed in claim 6 or 7, characterized in that the omega-6 fatty acid is linoleic acid.

9. A composition as claimed in any of claims 1 to 8, characterized in that it comprises as component (a) a mixture of a caprylic/capric acid triglyceride, oleic acid and/or linoleic acid.

10. A composition as claimed in any of claims 1 to 9, characterized in that the ratio of the amounts of omega-9 fatty acid and/or omega-6 fatty acid to the triglyceride is from 1:1 to 1:200, preferably from 1:2 to 1:20.

11. A composition as claimed in any of claims 1 to 10, characterized in that the surface-active component (b) comprises a polyoxyethylene sorbitan fatty acid ester, a polyoxyethylene glycolated natural or hydrogenated vegetable oil or mixtures thereof.

12. A composition as claimed in any of claims 1 and 3 to 11, characterized in that component (a) is present in an amount of from 20 to 70 percent by weight based on the total weight of the composition.

13. A composition as claimed in any of claims 1 and 3 to 12, characterized in that the surface-active component (b) is present in an amount of from 20 to 80 percent by weight based on the total weight of the composition.

14. A composition as claimed in any of claims 2 to 13, characterized in that it is an O/W microemulsion with an average particle size below 150 nm, preferably below 100 nm.

15. A composition as claimed in any of claims 1 to 14, characterized in that the triglyceride is a medium chain triglyceride.

16. A shaped article for oral administration comprising a composition as claimed in any of claims 1 and 3 to 13 and 15 for administering the active ingredient.

17. A shaped article as claimed in claim 16, characterized in that it comprises a biopolymer, in particular gelatin.

18. An effervescent tablet comprising a composition as claimed in any of claims 1 and 3 to 13 and 15 for administering the active ingredient.

19. A granulation comprising a composition as claimed in any of claims 1 and 3 to 13 and 15 for administering the active ingredient.

20. An effervescent tablet comprising a composition in the form of a microemulsion precondensate comprising
(a) a mixture consisting of a triglyceride and an omega-9 fatty acid and/or an omega-6 fatty acid; and
(b) a surface-active component comprising a surfactant, in particular of the polyoxy-ethylene type,
(c) an active ingredient selected from the class of ubiquinones, where the active ingredient is soluble in (a) and/or (b).

21. A granulation comprising a composition in the form of a microemulsion precondensate comprising
(a) a mixture consisting of a triglyceride and an omega-9 fatty acid and/or an omega-6 fatty acid; and
(b) a surface-active component comprising a surfactant, in particular of the polyoxy-ethylene type,
(c) an active ingredient selected from the class of ubiquinones, where the active ingredient is soluble in (a) and/or (b).

22. The use of a shaped article, granulation or effervescent tablet as claimed in any of claims 16 to 21, which decompose in the gastrointestinal tract, for the preparation of a medicament for releasing a composition which spontaneously forms a microemulsion with gastrointestinal fluid.
